(19) United States
(12) Patent Application Publication
(10) Pub. No.: US 2007/0184310 A1
(43) Pub. Date: Aug. 9, 2007

(54) Molten Carbonate Fuel Cell Provided with Indirect Internal Steam Reformer

(75) Inventors: Young Jin Kim, Daejeon (KR); In-Gab Chang, Daejeon (KR); Boo Ho Yoon, Daejeon (KR); Yun Sung Kim, Daejeon (KR); Gi-Pung Lee, Daejeon (KR); Kil-Ho Moon, Busan (KR); Tae Won Lee, Daejeon (KR)

Correspondence Address: CONLEY ROSE, P.C., 5700 GRANITE PARKWAY, SUITE 330, PLANO, TX, 75024, US

(73) Assignee: Doosan Heavy Industries & Construction Co., Ltd., Changwan-si (KR)

(21) Appl. No.: 11/617,470

(22) Filed: Dec. 28, 2006

(30) Foreign Application Priority Data
Feb. 7, 2006 (KR) 10-2006-0011847

(51) Int. Cl. H01M 8/06; H01M 8/24; H01M 2/08

(52) U.S. Cl. 429/20; 429/38; 429/35

(57) ABSTRACT

A molten carbonate fuel cell, which is provided with an indirect internal steam reformer to efficiently control heat and simplify the system construction and has a simple structure to reduce production cost and efficiently controls heat to reduce operational cost and increase operational efficiency, is disclosed. The molten carbonate fuel cell of the present invention has a plurality of unit cells each including a porous matrix plate which is interposed between an anode plate and a cathode plate and is filled with an alkali carbonate electrolyte, the unit cells being stacked on top of another; at least one indirect internal steam reformer interposed between the stacked unit cells and reforming a fuel to hydrogen through a reforming reaction and supplying the hydrogen to the unit cells; a fuel manifold air-tightly installed at an inlet of both the indirect internal steam reformer and the unit cells and receiving a fuel supply pipe therein to supply the fuel to the indirect internal steam reformer; and a reformed fuel manifold air-tightly installed at an outlet of both the indirect internal steam reformer and the unit cells and supplying the hydrogen produced by the indirect internal steam reformer to the unit cells.

### CROSS-REFERENCE TO RELATED APPLICATIONS

This application is claiming priority of Korean Application No. 10-2006-0011847, filed Feb. 7, 2006, and entitled “Molten Carbonate Fuel Cell Provided With Indirect Internal Steam Reformer” and which is incorporated herein by reference for all purposes.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

The present invention relates to a molten carbonate fuel cell with an indirect internal steam reformer and, more particularly, to a molten carbonate fuel cell which has an indirect internal steam reformer and a structure to efficiently control heat at a fuel cell stack, thus reducing operational cost and having increased operational efficiency.

### DESCRIPTION OF THE PRIOR ART

As well known to those skilled in the art, a molten carbonate fuel cell is a generating apparatus which can directly convert chemical energy of a fuel into electric energy through electrochemical reactions including a hydrogen oxidation reaction at an anode and an oxygen reduction reaction at a cathode. The molten carbonate fuel cell is an environment-friendly generating system which has increased ideal generating efficiency and produces a reduced amount of environment pollutants in comparison with conventional thermal engines, such as combustion engines.

The molten carbonate fuel cell typically comprises a stack to generate electricity, mechanical peripheral equipment, such as a fuel supply device, and electric peripheral equipment, such as an AC/DC converter.

In the conventional molten carbonate fuel cell, the stack has a plurality of unit cells each comprising an anode plate, a cathode plate and a porous matrix plate which is interposed between the anode and cathode plates and is filled with an alkali carbonate electrolyte. The stack is comprised of several ten or several hundred unit cells stacked together with conductive partition plates placed between the unit cells.

The stack typically determines generating efficiency, expected life span and operational performance of the molten carbonate fuel cell. Thus, the shape of the partition plates of the stack and the method of supplying fuel into the partition plates have been recognized as very important factors. In the related art, both the shape of the partition plates and the fuel supplying method thus have been actively studied. In the molten carbonate fuel cell, a steam reforming reaction which is an endothermic reaction is performed to produce gas laden with hydrogen from hydrogen and steam, and an oxidation reaction which is an exothermic reaction is performed. Thus, the molten carbonate fuel cell uses a reformer to reform the fuel and supply heat required in the steam reforming reaction.

The molten carbonate fuel cells have been typically classified into external reforming style fuel cells and internal reforming style fuel cells according to the location of the reformer. The external reforming fuel cell reforms fuel gas outside the fuel cell to produce both hydrogen and carbon dioxide and supplies the hydrogen and carbon dioxide to the anode of the fuel cell. The internal reforming fuel cell directly reforms fuel gas inside the fuel cell and supplies reformed gas to the anode. The internal reforming molten carbonate fuel cell directly uses the reaction heat, which has been produced from an electrochemical reaction, to a reforming reaction which is a separate endothermic reaction. Thus, conventional huge external reformers can be removed from the internal reforming molten carbonate fuel cell, thereby simplifying the system construction of the fuel cell and increasing thermal efficiency of the fuel cell.

Generally, the conventional internal reforming fuel cells have been classified into direct internal reforming style fuel cells and indirect internal reforming style fuel cells. In the direct internal reforming fuel cells, a reforming catalyst is directly charged in the anode so that the fuel cells can directly use heat produced from an electrochemical reaction of the anode, thus having improved reforming capacity. However, the direct internal reforming fuel cells are disadvantageous in that the catalytic capacity of the fuel cells is undesirably reduced due to evaporation of the electrolyte as time goes by. A technique to solve the problem of the conventional direct internal reforming fuel cells has been proposed in U.S. Pat. No. 5,660,941, and the technique to stop the reduction in the catalytic capacity due to the evaporation of the electrolyte has been actively and continuously studied. In the indirect internal reforming fuel cells, a chamber filled with the reforming catalyst is isolated from the anode so that the fuel cells can prevent evaporation of the electrolyte and prevent the reduction in the catalytic capacity of the fuel cells, thus retaining the catalytic capacity. Furthermore, the indirect internal reforming fuel cells can desirably control density of the catalyst prior to distribution of the catalyst, thus controlling the internal temperature of the stack.

The shapes of conventional molten carbonate fuel cells have been referred to the gazettes of Korean registered utility model No. 20-184143, Korean registered patent No. 10-266264, Korean patent Laid-open publication No. 10-2005-6651, and Korean registered patent No. 10-418626. The studies for the indirect internal reforming molten carbonate fuel cells include a study to use the fuel cells as a temperature control device or a hydrogen gas supply device, such as disclosed in U.S. patent Laid-open publication No. 2004/0071617.

However, the techniques disclosed in the above-mentioned patents and utility models are disadvantageous in that the fuel cells have complicated internal fluid lines and must require a complicated process of producing the partition plates, thus increasing the power consumption during operation of the fuel cells and increasing the production cost of the fuel cells.

### SUMMARY

Accordingly, the present invention has been made keeping in mind the above problems occurring in the prior art, and an object of the present invention is to provide a molten carbonate fuel cell which has an indirect internal steam reformer to efficiently control heat and simplify the system construction, thus having a simple structure and reducing production cost, and efficiently controlling heat to reduce operational cost and increase operational efficiency.

In order to achieve the above object, according to an aspect of the present invention, there is provided a molten carbonate fuel cell comprising: a plurality of unit cells each including a porous matrix plate which is interposed between an anode plate and a cathode plate and is filled with an alkali carbonate electrolyte, the unit cells being stacked on top of another, at least one indirect internal steam reformer interposed between the stacked unit cells and reforming a fuel to hydrogen through a reforming reaction and supplying the hydrogen to the unit cells; a fuel manifold air-tightly installed at an inlet of both the indirect internal steam reformer and the unit cells and receiving a fuel supply pipe therein to supply the fuel to the indirect internal steam reformer; and a reformed fuel manifold air-tightly installed at an outlet of both the indirect internal steam reformer and the unit cells and supplying the hydrogen produced by the indirect internal steam reformer to the unit cells.

The indirect internal steam reformer may comprise: an upper plate and a lower plate each including sidewalls along opposite sides thereof, thus forming a box-shaped duct when the upper and lower plates are combined together; a corrugated gas passage plate interposed between the upper and lower plates and coated with a reforming catalyst to reform the fuel while the fuel flows on the corrugated gas passage plate; a fuel supply diffuser connected to the fuel supply pipe and having a structure to distribute the fuel to gas passages of the corrugated gas passage plate without reducing pressure of the fuel; and a plurality of sealing plates installed at front and rear ends of the box-shaped duct to prevent leakage of the fuel and combine the manifolds to each other.

The fuel supply diffuser may be connected to the fuel supply pipe through a connection pipe having an electric insulating material therein.

The amount of the reforming catalyst coated on the corrugated gas passage plate may be partially controlled.

The molten carbonate fuel cell may further comprise: a plurality of manifold gaskets extending in vertical directions and installed at the inlets and outlets of the stacked unit cells and the indirect internal steam reformer, and allowing the manifolds to be installed thereon.

The manifold gaskets may be made of a nonconductive material.

In order to achieve the above object, according to another aspect of the present invention, there is provided an indirect internal steam reformer interposed between a plurality of stacked unit cells of a molten carbonate fuel cell and reforming a fuel to hydrogen through a reforming reaction and supplying the hydrogen to the unit cells, comprising: an upper plate and a lower plate each including sidewalls along opposite sides thereof, thus forming a box-shaped duct when the upper and lower plates are combined together, a corrugated gas passage plate interposed between the upper and lower plates and coated with a reforming catalyst to reform the fuel while the fuel flows on the corrugated gas passage plate; a fuel supply diffuser connected to the fuel supply pipe and having a structure to distribute the fuel to gas passages of the corrugated gas passage plate without reducing pressure of the fuel; and a plurality of sealing plates installed at front and rear ends of the box-shaped duct to prevent leakage of the fuel and combine a fuel manifold and a reformed fuel manifold installed at inlet and outlet of the box-shaped duct to each other.

### BRIEF DESCRIPTION OF THE DRAWINGS

The above and other objects, features and other advantages of the present invention will be more dearly understood from the following detailed description when taken in conjunction with the accompanying drawings.

FIG. 1 is a perspective view illustrating a part of a stack of a molten carbonate fuel cell having both unit cells and indirect internal steam reformers according to the present invention.

FIG. 2 is a perspective view illustrating an indirect internal steam reformer used in the stack of FIG. 1, which is partially broken at the top to show the structure of a corrugated gas passage plate provided in the reformer.

FIG. 3 is an exploded perspective view showing the construction of the indirect internal steam reformer.

FIG. 4 is a view showing gas currents flowing on the corrugated gas passage plate provided in the indirect internal steam reformer.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

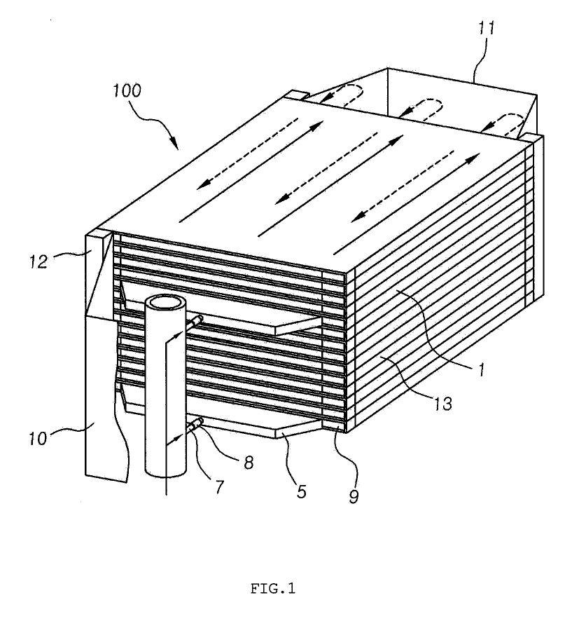

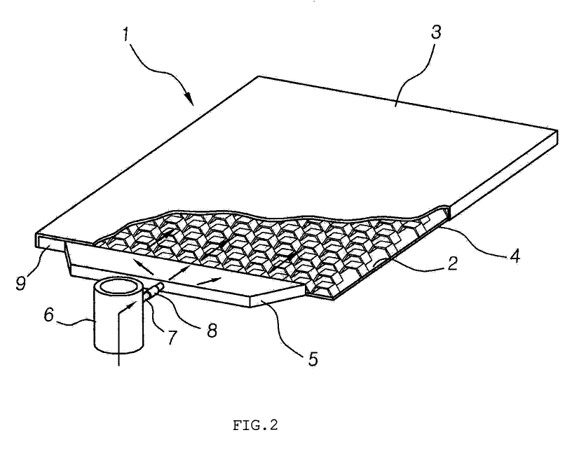

FIG. 1 is a perspective view illustrating a part of a stack of a molten carbonate fuel cell having both unit cells and indirect internal steam reformers according to the present invention. FIG. 2 is a perspective view illustrating an indirect internal steam reformer used in the stack of FIG. 1, which is partially broken at the top to show the structure of a corrugated gas passage plate provided in the reformer.

As shown in FIGS. 1 and 2, the fuel cell stack 100 using the indirect internal steam reformers according to the present invention is comprised of a plurality of unit cells 13 stacked with an indirect internal steam reformer 1 interposed between the unit cells 13. Each of the unit cells 13 comprises a porous matrix plate which is interposed between an anode plate and a cathode plate and is filled with an alkali carbonate electrolyte. The unit cells 13 are stacked on top of another. In the stack 100, a plurality of manifold gaskets 12 extend in vertical directions and are installed at the inlets and outlets of the stacked unit cells 13 and the indirect internal steam reformers 1, and allow a fuel manifold 10 and a reformed fuel manifold 11 to be installed thereon.

The fuel manifold 10 receives a vertically extending fuel supply pipe 6 therein and supplies a raw fuel having rich methane to the indirect internal steam reformers 1 through the fuel supply pipe 6. The fuel supply pipe 6 is connected to the indirect internal steam reformers 1 through a connection pipe 7. The connection pipe 7 which connects the fuel supply pipe 6 to the indirect internal steam reformers 1 must be provided with an electric insulating material therein. Thus, a short circuit between the manifolds 10 and 11 and the unit cells 13 can be prevented by the insulating material when the manifolds 10 and 11 are combined with the unit cells 13.

The connection pipe 7 is connected to a fuel supply diffuser 5 provided at the inlet of the indirect internal steam reformers 1. Inlet fuel supplied through the connection pipe 7 is distributed to a corrugated gas passage plate 2 through the fuel supply diffuser 5. The corrugated gas passage plate 2 is placed in each of the indirect internal steam reformers 1. The fuel which has been distributed to gas passages of the corrugated gas passage plate 2 through the fuel supply diffuser 5 is guided to the reformed fuel manifold 11 through the corrugated gas passage plate 2 as shown by the solid line in FIG. 1.

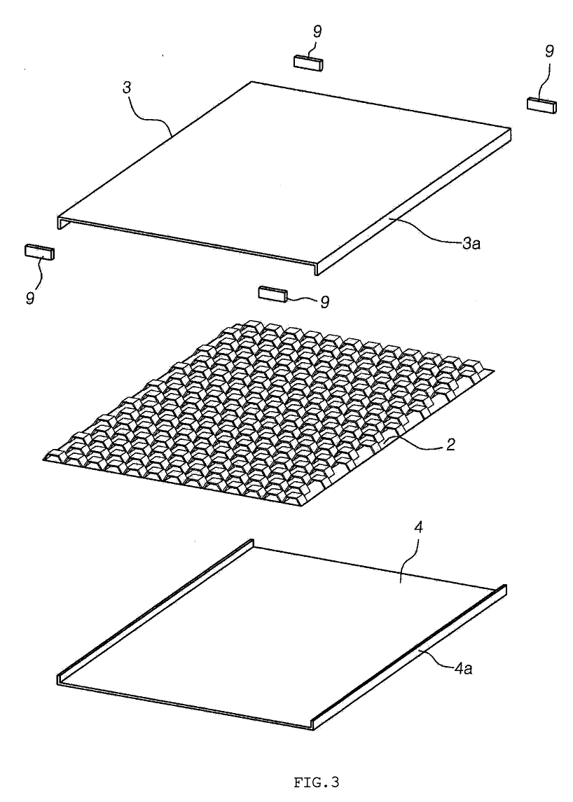

As shown in FIGS. 2 and 3, in the indirect internal steam reformer 1, the fuel supply diffuser 5 to distribute the fuel to the whole area of the corrugated gas passage plate 2 is placed at the intermediate position between the upper plate 3 and the lower plate 4. To prevent leakage of the fuel and combine the fuel manifold 10 to the indirect internal steam reformer 1, two sealing plates 9 are installed at opposite sides of the fuel supply diffuser 5. As described above, the manifold gaskets 12 are installed on the sealing plates 9. The manifold gaskets 12 and an electric insulating material 8 are made of a nonconductive material. The manifold gaskets 12 are combined with the fuel manifold 10 to isolate the interior of the fuel manifold 10 from the outside, thus maintaining air-tightness of the interior of the fuel manifold 10.

As described above, in the indirect internal steam reformer 1, a reforming catalyst to reform the fuel is coated on the surface of the corrugated gas passage plate 2. While the inlet raw fuel flows on the corrugated gas passage plate 2, the fuel is reformed to hydrogen through a methane-steam reforming reaction by the reforming catalyst coated on the surface of the corrugated gas passage plate 2.

The corrugated gas passage plate 2 is preferably shaped as a unidirectional gas passage plate as shown in FIG. 2 and distributes the fuel to minimize the inactivated area and minimize pressure reduction.

FIG. 3 is an exploded perspective view showing the construction of the indirect internal steam reformer. As shown in FIG. 3, the indirect internal steam reformer 1 of the present invention includes the upper plate 3 and the lower plate 4 each provided with sidewalls 102a and 103a along opposite sides thereof to form a U-shaped cross-section. When the upper and lower plates 3 and 4 are combined to each other, the plates 3 and 4 form a box-shaped duct as shown in the drawings.

Before the upper and lower plates 3 and 4 are combined to each other, the corrugated gas passage plate 2 is installed between the upper and lower plates 3 and 4. When the corrugated gas passage plate 2 is installed between the upper and lower plates 3 and 4, the corrugated gas passage plate 2 is placed such that the gas passages of the plate 2 are parallel to the sidewalls 3a and 4a of the upper and lower plates 3 and 4, thus allowing the fuel to smoothly flow through the gas passages of the corrugated gas passage plate 2. When the corrugated gas passage plate 2 is installed as described above, the upper plate 3 and the lower plate 4 are combined with each other at the top and bottom.

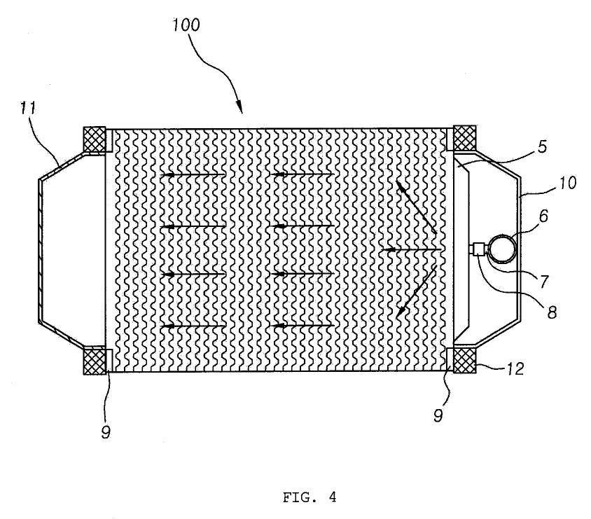

At opposite sides of the box-shaped duct formed by the upper and lower plates 3 and 4, the sealing plates 9 are installed as shown in FIG. 4. The sealing plates 9 are provided with the respective manifold gaskets 12 to prevent leakage of the fuel as described above. The fuel supply diffuser 5 connected to the connection pipe 7 is placed between the sealing plates 9 mounted at the inlet of the box-shaped duct. The fuel manifold 10 is installed between the manifold gaskets 12 outside the fuel supply diffuser 5. Furthermore, the reformed fuel manifold 11 is installed between the manifold gaskets 12 mounted to the sealing plates 9 installed at the outlet of the box-shaped duct. As described above, the indirect internal steam reformer 1 of the present invention is configured as a single body to minimize the number of welded portions for achieving tightness.

As shown in FIG. 1, while the fuel flows to the indirect internal steam reformers 1 through the fuel supply pipe 6, the fuel is preheated to a predetermined temperature through a heat exchanging process executed between the fuel and the fuel manifold 10 prior to being guided to the fuel supply diffuser 5. In the present invention, the fuel supply diffuser 5 is configured to minimize pressure reduction which may be generated during the diffusing distribution of the fuel and to evenly distribute the fuel to the corrugated gas passage plate 2.

While the fuel supplied to the indirect internal steam reformer 1 flows through the gas passages of the corrugated gas passage plate 2 provided in the indirect internal steam reformer 1, the fuel is reformed to hydrogen through the methane-steam reforming reaction executed by the reforming catalyst coated on the surface of the corrugated gas passage plate 2. The methane-steam reforming reaction executed by the reforming catalyst is an endothermic reaction and heat required in the methane-steam reforming reaction can be obtained from heat transfer using the convection-conduction action of caloric power generated by the electrochemical reaction of the unit cells 13. Thus, the amount of reforming catalyst coated on the surface of the corrugated gas passage plate 2 can be partially controlled so that the temperatures of both the indirect internal steam reformers 1 and the unit cells 13 can be controlled. The temperature of the fuel cell stack of the present invention can be also controlled. Furthermore, while the fuel passes on the corrugated gas passage plate 2, the hydrogen produced through reforming the fuel is supplied from the reformed fuel manifold 11 to the unit cells 13 after the flowing direction has been changed to another direction as shown by the dotted arrow in FIG. 1.

The hydrogen which has been supplied to the unit cells 13 is subjected to an anode oxidation reaction to produce water and carbon dioxide and, at the same time, electricity is produced. The anode oxidation reaction is an exothermic reaction and increases the temperature of the fuel cell stack 100. The uneven temperature of the stack 100 caused by the anode oxidation reaction induces residual thermal stress in the partition plates of the unit cells 13 and vaporizes the electrolyte, and promotes collision of the partition plates of the unit cells 13, thus reducing the operational performance and the expected life span of the stack 100.

Thus, to control the uneven temperature of the fuel cell stack 100, the amount of the reforming catalyst coated on the surface of the corrugated gas passage plate 2 installed in each of the indirect internal steam reformers 1 is desirably distributed and the temperature of the stack 100 can be preferably controlled. The operational performance of the stack 100 can be improved and the durability of the fuel cell can be improved to stabilize the operational performance of the molten carbonate style generating system. Unreacted fuel, water and carbon dioxide are collected by the fuel manifold 10 and drained outside the stack 100.

As is apparent from the above description, the molten carbonate fuel cell provided with indirect internal steam reformers according to the present invention provides advantages in that the reformers using a methane-steam reforming reaction are directly installed in the fuel cell stack to reform gas in the indirect internal steam reformers and supply the reforming products, that are hydrogen and carbon dioxide, to the anode. Thus, the present invention uses high temperature operational heat of the stacked molten carbonate fuel cells as reforming reaction heat which is an endothermic reaction, thereby preventing an excessive increase in the inner temperature of the stack and reducing the temperature grade. The present invention increases the expected life span of the fuel cell and improves the operation performance of the fuel cell. Particularly, because the outside reformer is removed from the system, the construction of the system can be simplified.

Furthermore, the indirect internal steam reformer of the present invention is configured as a duct style and has a simple shape, and simplifies the production process and allows a user to easily perform welding work and sealing work. In addition, the construction of the fuel cell of the present invention is simplified such that the flow direction of raw gas can be set to a single direction, thus minimizing the pressure loss and reducing power loss and increasing the system efficiency.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A molten carbonate fuel cell comprising:
a plurality of unit cells each including a porous matrix plate which is interposed between an anode plate and a cathode plate and is filled with an alkali carbonate electrolyte, the unit cells being stacked on top of another;
at least one indirect internal steam reformer interposed between the stacked unit cells and reforming a fuel to hydrogen through a reforming reaction and supplying the hydrogen to the unit cells;
a fuel manifold air-tightly installed at an inlet of both the indirect internal steam reformer and the unit cells and receiving a fuel supply pipe therein to supply the fuel to the indirect internal steam reformer; and
a reformed fuel manifold air-tightly installed at an outlet of both the indirect internal steam reformer and the unit cells and supplying the hydrogen produced by the indirect internal steam reformer to the unit cells.

2. The molten carbonate fuel cell according to claim 1, wherein the indirect internal steam reformer comprises:
an upper plate and a lower plate each including sidewalls along opposite sides thereof, thus forming a box-shaped duct when the upper and lower plates are combined together;
a corrugated gas passage plate interposed between the upper and lower plates and coated with a reforming catalyst to reform the fuel while the fuel flows on the corrugated gas passage plate;
a fuel supply diffuser connected to the fuel supply pipe and having a structure to distribute the fuel to gas passages of the corrugated gas passage plate without reducing pressure of the fuel; and
a plurality of sealing plates installed at front and rear ends of the box-shaped duct to prevent leakage of the fuel and combine the manifolds to each other.

3. The molten carbonate fuel cell according to claim 2, wherein the fuel supply diffuser is connected to the fuel supply pipe through a connection pipe having an electric insulating material therein.

4. The molten carbonate fuel cell according to claim 2, wherein the amount of the reforming catalyst coated on the corrugated gas passage plate is able to be partially controlled.

5. The molten carbonate fuel cell according to claim 1, further comprising:
a plurality of manifold gaskets extending in vertical directions and installed at the inlets and outlets of the stacked unit cells and the indirect internal steam reformer, and allowing the manifolds to be installed thereon.

6. The molten carbonate fuel cell according to claim 5, wherein the manifold gaskets are made of a nonconductive material.

7. An indirect internal steam reformer interposed between a plurality of stacked unit cells of a molten carbonate fuel cell and reforming a fuel to hydrogen through a reforming reaction and supplying the hydrogen to the unit cells, comprising:
an upper plate and a lower plate each including sidewalls along opposite sides thereof, thus forming a box-shaped duct when the upper and lower plates are combined together;
a corrugated gas passage plate interposed between the upper and lower plates and coated with a reforming catalyst to reform the fuel while the fuel flows on the corrugated gas passage plate;
a fuel supply diffuser connected to the fuel supply pipe and having a structure to distribute the fuel to gas passages of the corrugated gas passage plate without reducing pressure of the fuel; and
a plurality of sealing plates installed at front and rear ends of the box-shaped duct to prevent leakage of the fuel and combine a fuel manifold and a reformed fuel manifold installed at inlet and outlet of the box-shaped duct to each other.

8. The indirect internal steam reformer according to claim 7, wherein the fuel supply diffuser is connected to the fuel supply pipe through a connection pipe having an electric insulating material therein.

9. The indirect internal steam reformer according to claim 7, wherein the amount of reforming catalyst coated on the corrugated gas passage plate is able to be partially controlled.
